(19) United States
(12) Patent Application Publication
(10) Pub. No.: US 2018/0268437 A1
(43) Pub. Date: Sep. 20, 2018

(54) CALCULATION APPARATUS, CALCULATION METHOD, AND NON-TRANSITORY COMPUTER READABLE STORAGE MEDIUM

(71) Applicant: YAHOO JAPAN CORPORATION, Tokyo (JP)

(72) Inventor: Yoshihito NISHIKAWA, Tokyo (JP)

(73) Assignee: YAHOO JAPAN CORPORATION, Tokyo (JP)

(21) Appl. No.: 15/889,605

(22) Filed: Feb. 6, 2018

(30) Foreign Application Priority Data
Mar. 16, 2017 (JP) 2017-051750

(51) Int. Cl. G06Q 30/02

(52) U.S. Cl. CPC G06Q 30/0249; G06Q 30/0251; G06Q 30/0275

(57) ABSTRACT

A calculation apparatus includes an accepting unit that accepts, from a set-up person, a budget amount that is a maximum amount of compensation for distribution of information. The calculation apparatus includes a calculating unit that calculates, in accordance with the budget amount, the number of users who become the distribution destination of the information.

### CROSS-REFERENCE TO RELATED APPLICATIONS

The present application claims priority to and incorporates by reference the entire contents of Japanese Patent Application No. 2017-051750 filed in Japan on Mar. 16, 2017.

### BACKGROUND OF THE INVENTION

### 1. Field of the Invention

The present invention relates to a calculation apparatus, a calculation method, and a non-transitory computer readable storage medium.

### 2. Description of the Related Art

In recent years, with the rapid spread of the Internet, information distribution based on information acquired via a network has been actively performed. For example, targeting distribution in which an attribute of a user corresponding to the distribution destination of the information is previously registered as distribution destination information and an advertisement associated with the attribute of the user corresponding to the distribution destination is selectively distributed is performed.

Japanese Laid-open Patent Publication No. 2015-230717

However, in the conventional technology described above, there may be a case in which information is not always distributed in an appropriately way in accordance with a budget.

For example, if a plurality of advertisements to be provided to users who have the same attribute is present, there is known advertisement distribution with a bidding system that distributes, with priority, information of which compensation amount with respect to distribution is the highest. Furthermore, in information distribution with the bidding system, the upper limit of the compensation amount within a predetermined period of time is previously set as a budget. In advertisement distribution with the bidding system described above, if the compensation amount is raised, the number of times of distribution of information is increased and, thus, an acquisition unit price of a user is accordingly increased. In contrast, if the compensation amount is lowered, although the acquisition unit price of the user is lowered but distribution is not performed and thus the budget may possibly be left.

### SUMMARY OF THE INVENTION

It is an object of the present invention to at least partially solve the problems in the conventional technology.

According to one aspect of an embodiment a calculation apparatus includes an accepting unit that accepts, from a set-up person, a budget amount that is a maximum amount of compensation for distribution of information. The calculation apparatus includes a calculating unit that calculates, in accordance with the budget amount, the number of users who become the distribution destination of the information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a calculation process and an expanding process performed by an information distribution device according to an embodiment;

FIG. 2 is a diagram illustrating an example of the expanding process performed by the information distribution device according to the embodiment;

FIG. 3 is a diagram illustrating a configuration example of the information distribution device according to the embodiment;

FIG. 4 is a diagram illustrating an example of information registered in a user database according to the embodiment;

FIG. 5 is a diagram illustrating an example of information registered in an advertisement database according to the embodiment;

FIG. 6 is a diagram illustrating an example of information registered in a campaign database according to the embodiment;

FIG. 7 is a diagram illustrating an example of an expected CPA estimated by the information distribution device according to the embodiment;

FIG. 8 is a flowchart illustrating an example of the flow of a process performed by the information distribution device according to the embodiment; and

FIG. 9 is a diagram illustrating an example of hardware configuration.

### DETAILED DESCRIPTION OF THE PREFERRED EMBODIMENTS

A mode (hereinafter, referred to as an “embodiment”) for carrying out a calculation apparatus, a calculation method, and a non-transitory computer-readable storage medium having stored therein a determination program according to the present application will be described in detail below with reference to the accompanying drawings. The calculation apparatus, the calculation method, and the non-transitory computer-readable storage medium having stored therein the calculation program according to the present application are not limited by the embodiment. Furthermore, in the embodiments below, the same components are denoted by the same reference numerals and overlapping descriptions will be omitted.

### 1. Example of an Information Distribution Device

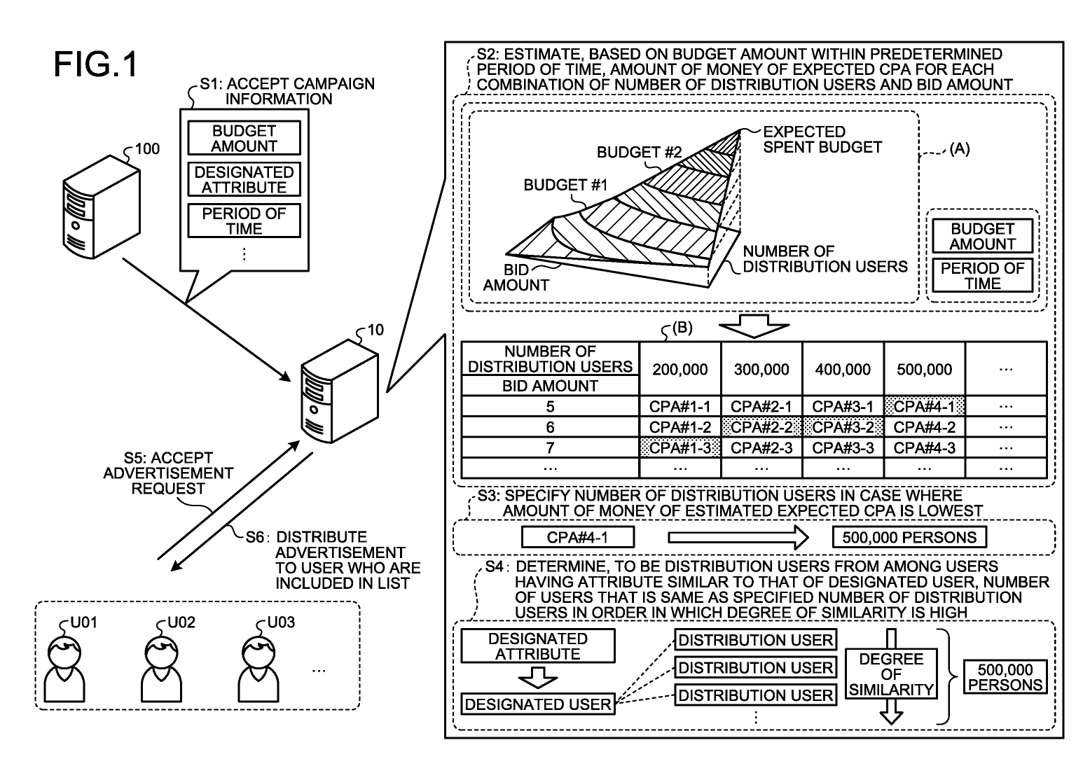

First, an example of a calculation process and an expanding process performed by an information distribution device that is an example of the calculation apparatus will be described with reference to FIG. 1. FIG. 1 is a diagram illustrating an example of the calculation process and the expanding process performed by an information distribution device according to an embodiment.

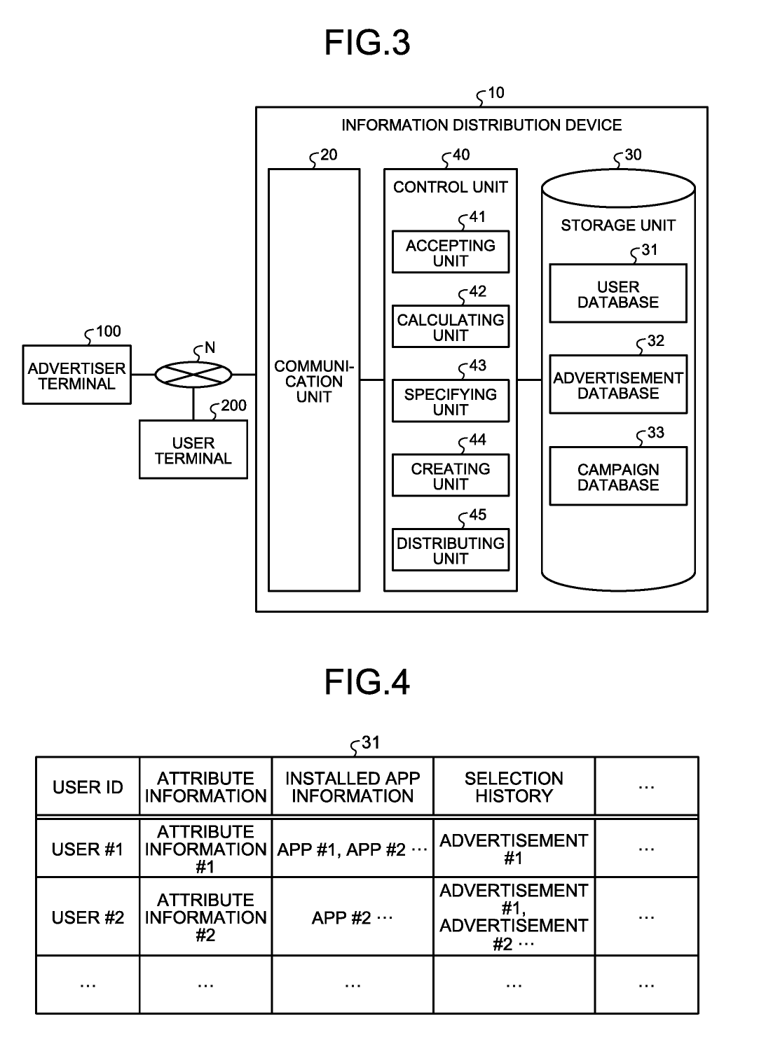

Furthermore, in a description below, an example in which content related to an advertisement is distributed to a user terminal 200 (for example, see FIG. 3), such as a mobile portable terminal, that is used by each of users U01 to U03 (hereinafter, sometimes collectively referred to as a “user U”) will be described; however, the embodiment is not limited to this. Namely, an information distribution device 10 may also distribute arbitrary content other than the advertisement to the user U.

Furthermore, it is assumed that the content related to an advertisement mentioned here is not only content related to a profit-orientated or a nonprofit advertisement but also other arbitrary content related to recruitment of volunteers, public advertisements, notice to the public, or the like. Namely, in addition to the content that includes information related to a so-called advertisement, other arbitrary content, such as images, moving images, characters, diagrams, symbols, or hyperlinks, may also be included together with texts as long as the content attracts user's interest and announces information that is included in the content or information that is included in content (for example, a landing page, etc.) related to the content. Furthermore, if the content is content related to an advertisement, an information processing apparatus (for example, an advertiser terminal 100) that registers the advertisement may be not only an information processing apparatus used by a so-called advertiser but also an information processing apparatus used by an advertising agency that creates or registers advertisements requested by an advertiser.

The information distribution device 10 is an information processing apparatus that can communicate with the advertiser terminal 100 and the user terminal 200 (for example, see FIG. 3) used by the user U via a predetermined network N, such as the Internet, and is implemented by, for example, a server device, a cloud system, or the like. Furthermore, the information distribution device 10 may also communicate with, via the network N, an arbitrary number of the advertiser terminals 100 and the user terminals 200.

The advertiser terminal 100 is an information processing apparatus used by the distribution source of an advertisement and is implemented by a server device, a PC, or the like. For example, when the advertiser terminal 100 registers an advertisement that becomes the distribution target in the information distribution device 10, the advertiser terminal 100 registers campaign information. Here, the campaign is a unit of a period of time, a budget, or the like at the time of distribution of a certain advertisement and the campaign information is information indicating a period of time for which an advertisement is distributed in a single campaign, an attribute of a user who becomes the distribution destination of the advertisement (hereinafter, referred to as a “designated attribute”), a budget amount that is the upper limit of compensation for distribution of the advertisement, an amount of money of a bid for distribution of the advertisement (hereinafter, referred to as a “bid amount”), or the like.

The user terminal 200 is a smart device, such as a smartphone, a tablet terminal, or the like, and is a mobile terminal device that can communicate with an arbitrary server device via a wireless communication network, such as third Generation (3G), Long Term Evolution (LTE), or the like. Furthermore, the user terminal 200 may also be, in addition to the smart device, an information processing apparatus, such as a desktop PC or a notebook PC. Furthermore, in the example illustrated in FIG. 1, the user terminal 200 used by each of the users U is not illustrated.

### 2. About Distribution of Advertisements

Here, the information distribution device 10 distributes advertisements in the bidding system. For example, if the information distribution device 10 accepts an advertisement request from the user U01, the information distribution device 10 compares the designated attribute of each of the advertisements that become the distribution target with the attribute information that indicates the attribute of the user U01 and extracts the advertisements of the designated attribute that matches the attribute of the user U. Then, the information distribution device 10 distributes, to the user U01, the advertisement with the highest bid amount from among the extracted advertisements. Furthermore, the attribute information on the user U01 described above is acquired by using a technology of, for example, cookies. However, in the bidding system described above, it is difficult to appropriately distribute information in a mode in accordance with a budget.

For example, as information that measures distribution effects of advertisements, there is known information referred to as a CPA (Cost Per Acquisition/Cost Per Action). This type of CPA is, for example, when the user U has purchased a transaction target related to an advertisement or when the user U has been guided to predetermined web content via an advertisement, an average value of compensation amount used by a single user to reach a predetermined conversion (i.e., an acquisition unit price of the user U) and is a value obtained by dividing, for example, a compensation sum total associated with distribution of an advertisement by the number of the users U who have reached the conversion.

Here, in the bidding system described above, in order to increase an opportunity to distribute advertisements, a bid amount is raised. However, if the bid amount is raised, the number of times of distribution of information is increased but, in contrast, an acquisition unit price of a user may possibly be raised. Furthermore, if the bid amount is raised, a budget is completely spent before elapse of a period of distribution time of an advertisement and, thus, there may possibly be a case of missing a distribution opportunity of an advertisement. In contrast, if the bid amount is lowered, the distribution opportunity of an advertisement is decreased and, thus, there may possibly be a case of not spending the budget.

### 2-1. About the Calculation Process

Thus, the information distribution device 10 performs the calculation process described below. First, the information distribution device 10 accepts, from a set-up person, a budget amount that is the maximum amount of compensation for distribution of an advertisement. Then, the information distribution device 10 calculates the number of users who become the distribution destination of the advertisement in accordance with the budget amount. More specifically, the information distribution device 10 accepts, as the budget amount, the maximum amount of compensation for distribution of the advertisement within a predetermined period of time. In such a case, the information distribution device 10 calculates, in accordance with the budget amount, the number of users who become the distribution destination of the advertisement within the predetermined period of time.

First, a description will be given of the relationship between the number of users who become the distribution destination of the advertisement (hereinafter, referred to as a “distribution user”) and the CPA that is expected in a predetermined period of time (hereinafter, referred to as an “expected CPA”). For example, as the distribution user, a user list in which users associated with designated attributes designated by an advertiser and other users similar to these users are sorted in the order of similarities will be considered.

In the user list described above, the number of times of selection of an advertisement selected by a predetermined number of distribution users in the order of users listed from the top will be considered. In this case, it is estimated that the number of times of selection of an advertisement selected by each of the distribution users is increased in a quadratic functional manner with respect to an increase in the number of distribution users.

Furthermore, in this user list, the ratio of users who reach conversion to the predetermined number of distribution users in the order of users from the top, i.e., a value of the CVR (conversion rate) will be considered. It is estimated that the value of such a CVR is decreased in a linear function manner with respect to an increase in the number of distribution users. Here, the number of times a user selects an advertisement is increased in accordance with an increase in a bid amount but becomes saturated when the bid amount exceeds a certain amount.

Based on the estimation described above, in order to guide a user to conversion, in the user list described above, a case of increasing the number of users who are to be selected as the distribution users is more efficient when compared with a case of increasing a bid amount.

In contrast, it is assumed that, if the number of distribution users is set to be constant, the budget amount spent within a predetermined period of time is increased in accordance with an increase in a bid amount. Furthermore, it is assumed that, if a bid amount is set to be constant, the budget amount spent within a predetermined period of time is increased in accordance with an increase in the number of users of the distribution destination. Consequently, it is assumed that, regarding a combination of the number of distribution users and a bid amount, the value of the CPA (hereinafter, referred to as an “expected CPA”) expected in a predetermined period of time is changed in accordance with the budget amount that is set by an advertiser.

Thus, in accordance with the budget amount that has been set by the advertiser, the information distribution device 10 estimates the value of the expected CPA related to a combination of the number of distribution users and the bid amount and specifies the bid amount and the number of distribution users such that the value of the estimated expected CPA is the lowest. Then, by distributing an advertisement to the specified number of distribution users, the information distribution device 10 implements distribution of information in an appropriate manner in accordance with the budget.

For example, the information distribution device 10 estimates, for each of the number of distribution users based on the budget amount, an acquisition compensation amount (i.e., the expected CPA) that is the compensation amount needed to acquire users and determines, based on the estimated acquisition compensation amount, the number of users who become the distribution destination of the advertisement, i.e., the number of distribution users. More specifically, for each combination of distribution compensation amount (i.e., a bid amount) that is a compensation amount with respect to distribution of an advertisement and the number of distribution user, the information distribution device 10 estimates an expected CPA based on the budget amount and determines the number of distribution users based on the estimated expected CPA. For example, the information distribution device 10 specifies the number of distribution users in a case where the expected CPA is the lowest.

### 2-2. About the Expanding Process

Here, it is conceivable that, depending on the attribute information selected by an advertiser, an advertisement is not able to be distributed to the specified number of distribution users. In contrast, if the number of distribution users is simply expanded, deviation is generated between users desired by an advertiser as the advertisement distribution destination and users to whom an advertisement is actually distributed. Thus, the information distribution device 10 expands the number of distribution users by creating the user list described above and increasing the number of users to be selected as the distribution users included in the created user list.

Namely, the information distribution device 10 specifies, as the distribution users, the number of users, who are similar to the designated user who has the designated attribute, that has been specified based on the value of the expected CPA in the order in which the degree of similarity to the designated user is high. Then, the information distribution device 10 distributes an advertisement to the specified user.

For example, the information distribution device 10 specifies, as the designated user, a user who has the same attribute as the designated attribute. In such a case, the information distribution device 10 specifies the advertisement that has been selected by the designated user and specifies all of the users who have selected the specified advertisement as candidates for the distribution users. Furthermore, the information distribution device 10 calculates the degree of similarity between each of the candidates for the distribution users and the designated users and sorts the candidates for the specified distribution users in the order in which the calculated degree of similarity is high. Furthermore, it is assumed that the designated users are included in the user targeted for the sorting. Then, in the order in which the degree of similarity to the designated users is high, the information distribution device 10 selects, as the distribution users, the number of candidates specified based on the expected CPA and creates a user list indicating the selected distribution users. Thereafter, the information distribution device 10 distributes an advertisement to the distribution users included in the created user list.

Furthermore, the information distribution device 10 may specify the user similar to the designated user based on an arbitrary reference as long as the information distribution device 10 specifies the user who is similar to the designated user. For example, the information distribution device 10 may also specify, as a candidate for the distribution user, another user who uses an application that is the same or similar to the application used by the designated user.

For example, the information distribution device 10 specifies the application used by the designated user and specifies, as a candidate for the distribution user, another user who uses the specified application. Furthermore, the information distribution device 10 specifies, as a candidate for the distribution user, another user who uses the same type of application as that used by the designated user. For example, if the designated user uses an application related to an electronic business transaction or an auction, in addition to the other user who uses the subject application, the information distribution device 10 also selects, as a candidate for the distribution user, a user who uses another application related to the electronic business transaction or the auction.

Then, the information distribution device 10 calculates the degree of similarity to the designated user, calculates the degree of similarity to each of the candidates and selects, as the distribution users, the number of candidates based on the expected CPA in the order in which the calculated degree of similarity is high. For example, the information distribution device 10 may also calculate the degree of similarity between attribute information indicating various attributes, such as a demographic attribute or a psychographic attribute of the designated user, and attribute information on each of the candidates and then select the distribution users in the order in which the calculated degree of similarity is high.

Furthermore, the information distribution device 10 may also calculate the degree of similarity of each of the users by considering a use mode of the application. For example, the information distribution device 10 may also calculate the degree of similarity of each of the users based on the degree of contribution with respect to the application, such as the use time of an application of a game or the like, a use time zone, a bill amount, the rate of dependence, a play content, such as the way to increase the level, or the like. Furthermore, the information distribution device 10 may also calculate the degree of similarity between a designated user and a candidate based on the degree of contribution to an application of different games.

Namely, the information distribution device 10 may also calculate the degree of similarity between the designated user and the candidate based on the attribute information on each of the users, may also calculate the degree of similarity of the application used by each of the users to install the application in the respective user terminals 200, or may also calculate the degree of similarity of the use mode of the application. Furthermore, the information distribution device 10 may also calculate the degree of similarity between the designated users and the candidates based on the degree of similarity of the advertisement selected by each of the users.

### 2-3. About Results of the Calculation Process and the Expanding Process

Furthermore, if the information distribution device 10 selects the number of distribution users calculated by the calculation process described above by the expanding process described above, the information distribution device 10 distributes the associated advertisements to the selected distribution users. However, the embodiment is not limited to this. For example, the information distribution device 10 may also provide, to an advertiser, the value of the expected CPA calculated by the calculation process or may also provide, to an advertiser, a bid amount or the number of distribution users in a case where the value of the expected CPA is the lowest, whereby the information distribution device 10 may also recommend an efficient advertisement distribution mode. Furthermore, by providing the user list created by the expanding process to an advertiser, the information distribution device 10 may also recommend an efficient advertisement distribution mode. Furthermore, the information distribution device 10 may also provide, to an advertiser as a report, the value of the expected CPA calculated by the calculation process or a bid amount or the number of distribution users in a case where an expected CPA is the lowest. As the results of the processes described above, because the information distribution device 10 can propose efficient distribution of advertisements with respect to an advertiser, for example, the information distribution device 10 can provide a motivation of distribution of a new advertisement to an advertiser.

Furthermore, the information distribution device 10 may also perform only one of the calculation process and the expanding process. For example, the information distribution device 10 may also be a device that calculates, in accordance with the budget of an advertiser, the number of distribution user or a bid amount in a case where the value of the expected CPA is the lowest and that provides, to an advertiser, the calculated number of distribution users or the bid amount. Furthermore, the information distribution device 10 may also be a device that specifies the designated user associated with the designated attribute designated by an advertiser and then specifies, as the distribution users, a predetermined number of users in the order in which the degree of similarity to the specified designated user is high. In such a case, the information distribution device 10 may also specify the number of distribution users desired by the advertiser or may also specify the number of distribution users who are set in accordance with the budget of the advertiser.

### 2-4. Example of the Calculation Process and the Expanding Process

In the following, an example of the calculation process and the expanding process performed by the information distribution device 10 will be described with reference to FIG. 1. FIG. 1 is a diagram illustrating an example of calculation process and the expanding process performed by the information distribution device 10 according to the embodiment.

First, the information distribution device 10 accepts campaign information from the advertiser terminal 100 (Step S1). For example, the information distribution device 10 accepts, as the campaign information, information, such as a budget amount, a designated attribute, and a period of time for which an advertisement is distributed. In this case, the information distribution device 10 estimates, based on the budget amount, for each combination of the number of distribution users and a bid amount, the amount of money of the expected CPA (Step S2).

For example, an example of a three-dimensional graph, which is indicated by (A) illustrated in FIG. 1, indicates a relationship with, for each bid amount and the number of distribution users, an expected spending budget that is expected to be spent within a predetermined period of time. Furthermore, in the example indicated by (A) illustrated in FIG. 1, the lateral direction represents a bid amount, the depth direction represents a distribution user, and the height direction represents the expected spending budget. In the three-dimensional graph, the region with the same height is presumed to be associated with the same budget.

In contrast, when considering a mode in which an advertiser appropriately uses up the budget in the period of time designated by the advertiser, the amount of expected spending budget allowed within a predetermined period of time is increased as the budget amount that has been set by the advertiser is increased. For example, if the value of a budget #2 is higher than that of a budget #1, the budget amount allowed within a predetermined period of time is presumed to be a higher value, as indicated by (A) illustrated in FIG. 1.

Thus, the information distribution device 10 calculates, based on the budget amount and the period of time designated by the advertiser, the budget amount within a predetermined period of time and then selects a combination of the bid amount and the number of distribution users in accordance with the calculated budget amount. For example, in the three-dimensional graph indicated by (A) illustrated in FIG. 1, the information distribution device 10 specifies the relationship between the bid amount and the number of distribution users at the height that is associated with the calculated budget amount. Then, the information distribution device 10 estimates the value of the expected CPA for each relationship between the selected bid amount and the number of distribution users.

For example, it is assumed that the combination of a bid amount and the number of distribution users in the case where an amount of money of the expected spending budget is a predetermined amount of money is the combination of the number of distribution users “200,000” and the bid amount “7”, the combination of the number of distribution users “300,000” and the bid amount “6”, the combination of the number of distribution users “400,000” and the bid amount “6”, and the combination of the number of distribution users “500,000” and bid amount “5”. In this case, as indicated by (B) illustrated in FIG. 1, the information distribution device 10 estimates an expected CPA “CPA#1-3” in the case where the number of distribution users is “200,000” and the bid amount is “7”, an expected CPA “CPA#2-2” in the case where the number of distribution users is “300,000” and the bid amount is “6”, an expected CPA “CPA#3-2” in the case where the number of distribution users is “400,000” and the bid amount is “6”, and an expected CPA “CPA#4-1” in the case where the number of distribution users is “500,000” and the bid amount is “5”. Furthermore, the information distribution device 10 may also previously estimate the expected CPA for each combination of the number of distribution users and the bid amount and may also select the expected CPA, out of the estimated expected CPA, that is associated with the combination of the number of distribution users and bid amount and that has been selected in accordance with the budget.

Namely, the information distribution device 10 selects a combination of a bid amount and the number of distribution users such that the amount of money expected to be spent within a predetermined period of time approaches the budget amount. Then, the information distribution device 10 specifies the number of distribution users in a case where the amount of money of the estimated expected CPA is the lowest (Step S3). For example, if the value of the “CPA#4-1” is the lowest out of the expected CPA selected at Step S2, the information distribution device 10 specifies the number of distribution users of “500,000” that is associated with the subject “CPA#4-1”.

Then, the information distribution device 10 determines that, from among the users having the attribute similar to that of the designated users, the users corresponding to the specified number of distribution users are distribution users in the order in which the degree of similarity is high (Step S4). For example, the information distribution device 10 specifies the designated user who has the attribute that is matched to or most similar to the designated attribute that has been selected by an advertiser. Subsequently, the information distribution device 10 calculates the degree of similarity between each of the specified designated users and other users, selects “500,000” users as the distribution users in the order in which the calculated degree of similarity is high as the distribution users, and creates a user list that indicates the selected distribution users. Then, if the information distribution device 10 accepts an advertisement request from, for example, the user U (Step S5), the information distribution device 10 determines whether the user U who is the request source is included in the user list and distributes, by distributing the advertisement if the user U is included in the user list, an advertisement to the user who is included in the user list (Step S6).

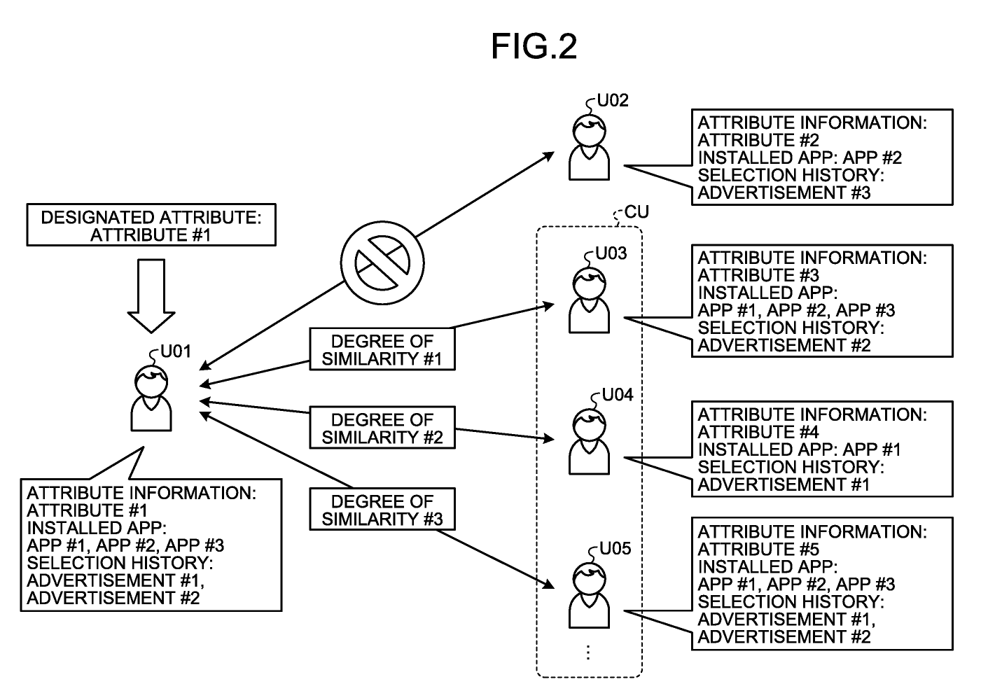

In the following, an example of the process of expanding the distribution users will be described with reference to FIG. 2. FIG. 2 is a diagram illustrating an example of the expanding process performed by the information distribution device according to the embodiment.

Furthermore, in the example illustrated in FIG. 2, it is assumed that the attribute information on a user U01 is an “attribute #1”; it is assumed that the application installed by the user U01 is an “app #1”, an “app #2”, and an “app #3”; and it is assumed that the advertisement selected by the user U01 is an “advertisement #1” and an “advertisement #2”. Furthermore, it is assumed that attribute information on a user U02 is an “attribute #2”; the application installed by the user U02 is the “app #2”; and the advertisement selected by the user U02 is an “advertisement #3”. Furthermore, it is assumed that the attribute information on a user U03 is an “attribute #3”; the application installed by the user U03 is the “app #1”, the “app #2”, and the “app #3”; and the advertisement selected by the user U03 is the “advertisement #2”. Furthermore, it is assumed that the attribute information on a user U04 is an “attribute #4”; the application installed by the user U04 is the “app #1”; and the advertisement selected by the user U04 is the “advertisement #1”. Furthermore, it is assumed that the attribute information on a user U05 is an “attribute #5”, the application installed by a user U05 is the “app #1”, the “app #2”, and the “app #3”; and the advertisement selected by the user U05 is the “advertisement #1” and the “advertisement #2”.

For example, it is assumed that the information distribution device 10 has accepted “attribute information #1” as a designated attribute. In this case, the information distribution device 10 selects, as the designated user, the user U01 who has the attribute of the “attribute information #1”. Then, the information distribution device 10 specifies another user who has selected the advertisement of the “advertisement #1” or the “advertisement #2” selected by the user U01. In the example illustrated in FIG. 2, the users U03 to U05 have selected the advertisement of the “advertisement #1” or the “advertisement #2”. However, the user U02 does not select the advertisement of the “advertisement #1” and the “advertisement #2”. Thus, the information distribution device 10 does not select the user U02 but selects the users U02 to U05 as the candidates CU for the distribution users.

Furthermore, the information distribution device 10 calculates each of the degree of similarities #1 to #3 between the user U01 and the other users U03 to U05. For example, the information distribution device 10 calculates each of the degree of similarities #1 to #3 based on commonalities, similarities, or the like of the installed application, the use mode of the application, the attribute information, the selected advertisement, or the like. Then, the information distribution device 10 creates a user list in which a predetermined number of users, i.e., the users U03 to U05, are listed in the order in which the calculated degree of similarities is high, i.e., #1 to #3.

### 3. Configuration of the Information Distribution Device

In the following, a description will be given of an example of a functional configuration included in the information distribution device 10 described above. FIG. 3 is a diagram illustrating a configuration example of the information distribution device according to the embodiment. As illustrated in FIG. 3, the information distribution device 10 includes a communication unit 20, a storage unit 30, and a control unit 40.

The communication unit 20 is implemented by, for example, a network interface card (NIC), or the like. Then, the communication unit 20 is connected to a network N in a wired or a wireless manner and sends and receives information to and from the information distribution device 10 or the user terminal 200.

The storage unit 30 is implemented by, for example, a semiconductor memory device, such as a random access memory (RAM), a flash memory, or the like, or a storage device, such as a hard disk, an optical disk, or the like. Furthermore, the storage unit 30 stores therein a user database 31, an advertisement database 32, and a campaign database 33.

In the following, an example of the information registered in each of the databases 31 to 33 will be described with reference to FIGS. 4 to 6. In the user database 31, information related of the user U who becomes the distribution destination of an advertisement is registered. For example, FIG. 4 is a diagram illustrating an example of information registered in the user database according to the embodiment. In the example illustrated in FIG. 4, in the user database 31, items, such as “user identifier (ID)”, “attribute information”, “installed app information”, “selection history”, and the like, are registered. Furthermore, in addition to the information illustrated in FIG. 4, arbitrary information related to the user U may also be registered in the user database 31.

Here, the “user ID” is information for identifying a user. The “attribute information” is information indicating an attribute of the user indicated by the associated “user ID”. The “installed app information” is information indicating an application installed in the user terminal 200 that is used by the user indicated by the associated “user ID”. The “selection history” is information indicating an advertisement that has been selected by the user indicated by the associated “user ID”.

For example, in the example illustrated in FIG. 4, a user ID “user #1”, the attribute information “attribute information #1”, the installed app information “app #1, app #2”, and the selection history “advertisement #1” are associated and registered. The information registered here indicates that the attribute of the user U indicated by the user ID “user #1” is the attribute indicated by the attribute information “attribute information #1” and indicates that the application indicated by the installed app information “app #1, app #2” is installed in the user terminal 200 that is used by the user U. Furthermore, the information registered here indicates that the user U indicated by the user ID “user #1” has selected the advertisement indicated by the “advertisement #1”.

Furthermore, in the example illustrated in FIG. 4, conceptual values, such as the “user #1”, the “attribute information #1”, the “app #1, app #2”, and the “advertisement #1”, are represented; however, in practice, in the user database 31, a character string for identifying the user U, a value or a character string indicating the attribute, a character string for identifying the application, a character string for identifying the selected advertisement, and the like are registered.

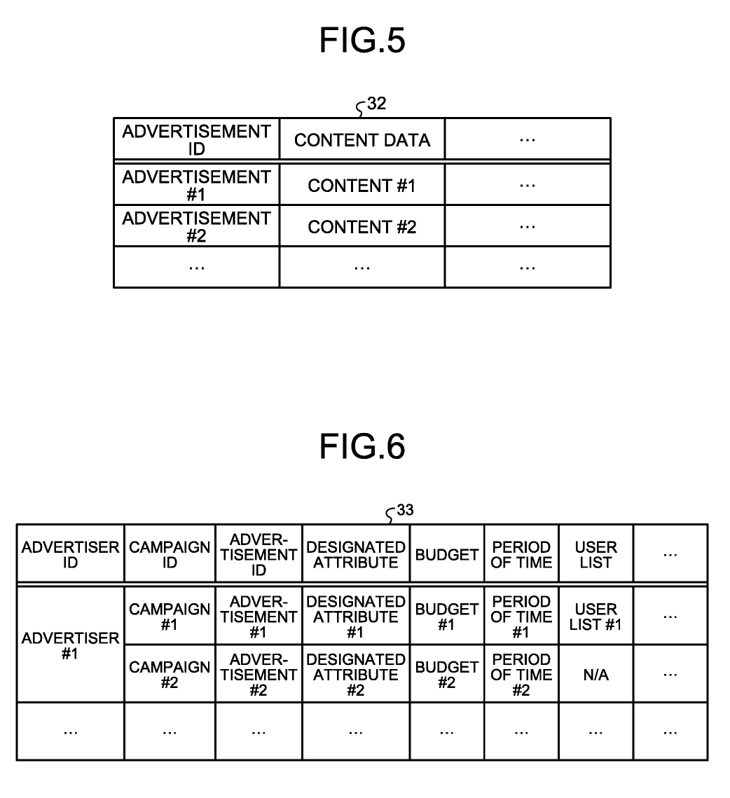

In the advertisement database 32, the advertisement that becomes the distribution target is registered. For example, FIG. 5 is a diagram illustrating an example of information registered in the advertisement database according to the embodiment. In the example illustrated in FIG. 5, in the advertisement database 32, the items, such as “advertisement ID”, “content data”, and the like, are registered. Furthermore, in addition to the information illustrated in FIG. 5, arbitrary information related to the advertisement may also be registered in the advertisement database 32.

For example, the “advertisement ID” is information for identifying the advertisement. The “content data” is data on various kinds of content of images, texts, voices, or the like distributed as the advertisement. For example, in the example illustrated in FIG. 5, in the advertisement database 32, the advertisement ID “advertisement #1” and the content data “content #1” are associated and registered. The information registered here indicates that data on the advertisement indicated by the advertisement ID “advertisement #1” is the content data “content #1”. Furthermore, in the example illustrated in FIG. 5, conceptual values, such as the “advertisement #1” and the “content #1”, are represented; however, in practice, a character string for identifying the advertisement or various kinds of data are registered.

In the campaign database 33, various kinds of information related to a campaign are registered. For example, FIG. 6 is a diagram illustrating an example of information registered in the campaign database according to the embodiment. In the example illustrated in FIG. 6, in the campaign database 33, items, such as “advertiser ID”, “campaign ID”, “advertisement ID”, “designated attribute”, “budget”, “period of time”, “user list”, and the like, are registered. Furthermore, in addition to the information illustrated in FIG. 6, arbitrary information related to the campaign may also be registered in the campaign database 33.

Here, the “advertiser ID” is information for identifying the advertiser. Furthermore, the “campaign ID” is information for identifying a campaign that is set by the advertiser indicated by the associated “advertiser ID”. Furthermore, the “advertisement ID” is information for identifying an advertisement distributed in accordance with the campaign indicated by the associated “campaign ID”. Furthermore, the “designated attribute” is information indicating the designated attribute that has been designated by the advertiser in the campaign indicated by the associated “campaign ID”. The “budget” and the “period of time” is the budget and the period of time, respectively, in the campaign indicated by the associated “campaign ID”. The “user list” is the user list created by the calculation process or the expanding process as the distribution destination of the advertisement indicated by the associated “advertisement ID”.

For example, in the example illustrated in FIG. 6, an advertiser ID “advertiser #1”, a campaign ID “campaign #1”, the advertisement ID “advertisement #1”, a designated attribute “designated attribute #1”, a budget “budget #1”, a period of time “period of time #1”, and a user list “user list #1” are associated and registered. The information registered here indicates that the campaign indicated by the campaign ID “campaign #1” is set by the advertiser indicated by the advertiser ID “advertiser #1” and indicates that the advertisement distributed in this campaign is the advertisement indicated by the advertisement ID “advertisement #1”. Furthermore, the information registered here indicates that, in the campaign indicated by the campaign ID “campaign #1”, the user who has the same attribute as the designated attribute “designated attribute #1” is designated as the distribution destination; indicates that the maximum amount of compensation for distribution of the advertisement, i.e., the budget is the “budget #1”; and indicates that the period of time of the campaign is the “period of time #1”. Furthermore, the information registered here indicates that, in the campaign indicated by the campaign ID “campaign #1”, user list “user list #1” has been created by the calculation process or the expanding process.

Furthermore, in the example illustrated in FIG. 6, conceptual values, such as the “advertiser #1”, the “campaign #1”, the designated attribute “designated attribute #1”, the “budget #1”, the “period of time #1”, and the “user list #1”, are represented; however, in practice, an advertiser, a campaign, a character string indicating a designated attribute, a value indicating a budget, a value indicating a period of time, a user ID for identifying a distribution user, and the like are associated and registered.

A description will be continued by referring back to FIG. 3. The control unit 40 is a controller and is implemented by, for example, a processor, such as a central processing unit (CPU), a micro processing unit (MPU), or the like, executing various kinds of programs, which are stored in a storage device in the information distribution device 10, by using a RAM or the like as a work area. Furthermore, the control unit 40 is a controller and may also be implemented by, for example, an integrated circuit, such as an application specific integrated circuit (ASIC), a field programmable gate array (FPGA), or the like.

As illustrated in FIG. 3, the control unit 40 includes an accepting unit 41, a calculating unit 42, a specifying unit 43, a creating unit 44, and a distributing unit 45. The accepting unit 41 accepts, from a set-up person, i.e., an advertiser, a budget amount that is the maximum amount of compensation for distribution of information. More specifically, the accepting unit 41 accepts, as a budget amount, the maximum amount of compensation for distribution of information within a predetermined period of time.

For example, the accepting unit 41 accepts, from the advertiser terminal 100, an advertisement that becomes the distribution target and various kinds of campaign information at the time of distribution of the advertisement. In this case, the accepting unit 41 attaches the advertisement ID to the advertisement, registers the advertisement ID in the advertisement database 32, and registers the campaign information, such as the budget amount and the period of time, in the campaign database 33 in association with the advertisement ID and the advertiser ID of the advertiser.

The calculating unit 42 calculates the number of users who become the distribution destination of the advertisement in accordance with the budget amount. More specifically, the calculating unit 42 calculates the number of users who become the distribution destination of the advertisement within a predetermined period of time in accordance with the budget amount. For example, for each number of users who become the distribution destination of the advertisement, i.e., for each number of distribution users, the calculating unit 42 estimates, based on the budget amount, the acquisition compensation amount that is the compensation amount needed to acquire a user and determines, based on the estimated acquisition compensation amount, the number of users who become the distribution destination of the advertisement.

For example, the calculating unit 42 estimates, for each combination of the bid amount and the number of distribution users, the expected CPA based on the budget amount and determines the number of distribution users based on the estimated expected CPA. More specifically, the calculating unit 42 selects the combination of the bid amount and the number of distribution users such that the amount of money expected to be spent within a predetermined period of time is within a predetermined range of the budget amount (for example, equal to or less than 1000 yen). Furthermore, the calculating unit 42 estimates each of the values of the expected CPA associated with the combination of the selected bid amount and the number of distribution users. Then, the calculating unit 42 specifies the number of distribution users in a case where the value of the estimated expected CPA is the lowest.

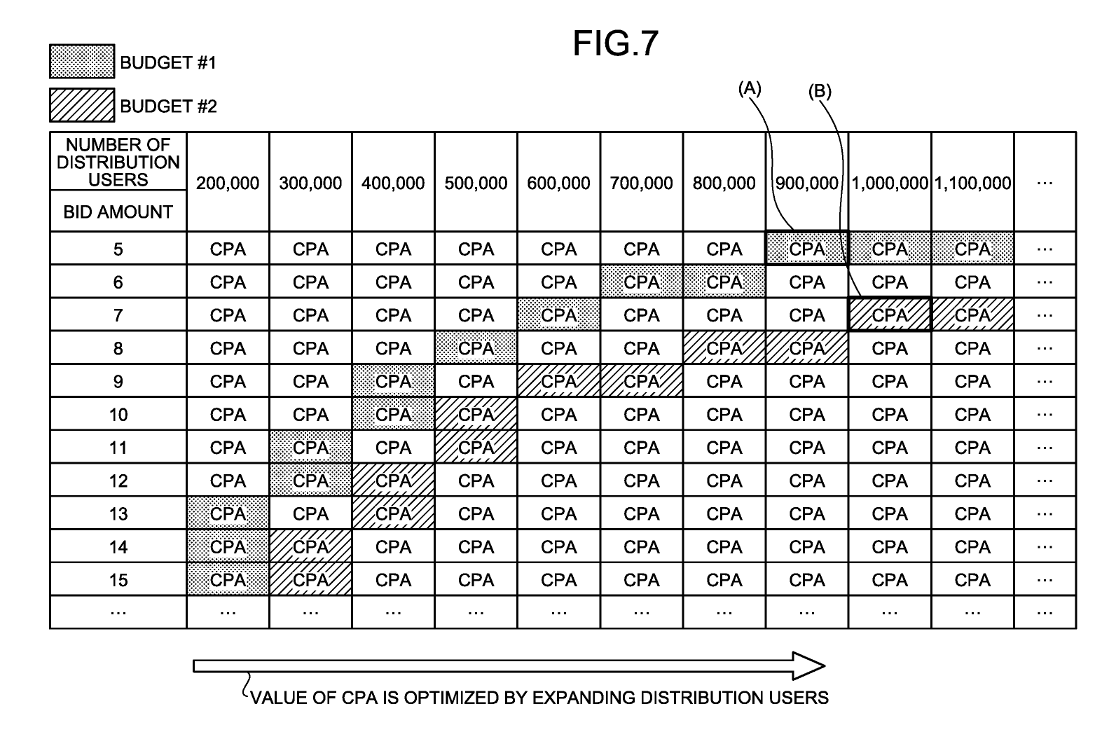

For example, FIG. 7 is a diagram illustrating an example of the expected CPA estimated by the information distribution device according to the embodiment. For example, as indicated by the table illustrated in FIG. 7, if the vertical axis represents a bid amount (yen) and the horizontal axis represents the number of distribution users (persons), a value indicating the expected CPA with a different value is estimated for each cell that is associated with a combination of the bid amount and the number of distribution users. Furthermore, in the example illustrated in FIG. 7, to simplify a description, descriptions of specific values of the expected CPA have been omitted.

In this table, for example, the combination of the bid amount and the number of distribution users in the case where a compensation sum total that is supposed to be generated at the time of elapse of a predetermined period of time, i.e., a budget amount that is expected to be spent at the time of elapse of a predetermined period of time, is the same as the budget #1 is associated with the cells represented by a dark gray color illustrated in FIG. 7. Furthermore, the combination of the bid amount and the number of distribution users in the case where a budget amount expected to be spent at the time of elapse of a predetermined period of time is the same as the budget #2, the amount of which is higher than that of the budget #1, is associated with the cells represented by a light gray color illustrated in FIG. 7.

Thus, the calculating unit 42 selects the cells, from among the cells illustrated in FIG. 7, that are associated with the combinations of the bid amounts and the number of distribution users in the case where the budget amount expected to be spent at the time of elapse of a predetermined period of time is the same as the budget amount designated by an advertiser. Then, the calculating unit 42 specifies the expected CPA having the lowest value out of the expected CPA included in the selected cells and then specifies the number of distribution users associated with the specified expected CPA. Here, the value of the expected CPA is increased as the bid amount is raised, whereas the value of the expected CPA is decreased as the number of distribution users is increased. Because of this, the calculating unit 42 optimizes the values of the expected CPA by expanding the number of distribution users.

For example, if the value of the expected CPA of the cell, which is indicated by (A) illustrated in FIG. 7, is the lowest with respect to the budget #1, the calculating unit 42 specifies the number of distribution users of “900,000”. If the value of the expected CPA of the cell, which is indicated by (B) illustrated in FIG. 7, is the lowest with respect to the budget #2, the calculating unit 42 specifies the number of distribution users of “1,000,000”. Consequently, the calculating unit 42 can calculate the number of distribution users that is in accordance with the budget and that has the minimum value of the expected CPA. Furthermore, the information distribution device 10 may also previously store, for example, the relationship between the combinations of the bid amounts and the number of distribution users illustrated in FIG. 7 and the values of the expected CPA and may also calculate the number of distribution users for each advertisement.

A description will be continued here by referring back to FIG. 3. The specifying unit 43 specifies the users who are similar to the designated user who has the designated attribute designated by the advertiser and the number of which is calculated by the calculating unit 42 in the order the degree of similarity between the designated user is high. Namely, by expanding the number of distribution users who become the distribution destination of the advertisement to the users similar to the designated users, the specifying unit 43 reserves the number of distribution users calculated by the calculating unit 42.

For example, the specifying unit 43 refers to the campaign database 33 and searches for the campaign in which the user list is not registered. Furthermore, if the campaign in which the user list is not registered has been registered, the specifying unit 43 extracts a designated attribute associated with the subject campaign and specifies, from the user database 31 as the designated user, the user whose attribute matches the extracted designated attribute. Furthermore, if a user having the attribute that completely matches the designated attribute is not present, the specifying unit 43 may also specify, as the designated user, the user whose attribute is most similar to the designated attribute.

Then, in the order in which the degree of similarity to the designated user is high, the specifying unit 43 specifies the number of users, who have selected the advertisement selected by the designated user, that has been calculated by the calculating unit 42. For example, the specifying unit 43 specifies the advertisement selected by the designated user from the user database 31 and specifies the users who have selected the specified advertisement as the candidates. Subsequently, the specifying unit 43 calculates the degree of similarity between the designated user and each of the candidates. For example, the specifying unit 43 calculates the degree of similarity between the designated user and each of the candidates in accordance with the attribute of the designated user and each of the candidates, the installed applications, and the use mode of the applications. Then, the specifying unit 43 determines that the number of candidates calculated by the calculating unit 42 is the distribution users in the order in which the calculated degree of similarity is high.

Furthermore, for example, the specifying unit 43 may also specify the number of users, who use an application similar to that used by the designated user by the number of users, that has been calculated by the calculating unit 42 in the order in which the degree of similarity to the designated user is high. For example, the specifying unit 43 may also specify, as a candidate, the user who uses the same application as that used by the designated user or the user who uses another application similar to the application used by the designated user. Furthermore, the specifying unit 43 may also specify, as a candidate, the users who has the attribute similar to that of the designated user. Namely, the specifying unit 43 may also select a distribution user based on an arbitrary reference as long as the specifying unit 43 can specify the number of distribution users calculated by the calculating unit 42 based on the similarity to the designated user based on the designated attribute that has been designated by an advertiser.

Furthermore, by performing the processes described above when an advertiser registers an advertisement or registers a new campaign, the specifying unit 43 may also expand or select the distribution users. Furthermore, the specifying unit 43 may also provide, for example, the expected CPA with the minimum value to an advertiser from among the distribution users the number of distribution users calculated by the calculating unit 42, and the expected CPA estimated by the calculating unit 42 in accordance with the budget amount, which corresponds to the result of the processes described above obtained when an advertiser registers an advertisement or registers a new campaign.

The creating unit 44 creates a user list. For example, the creating unit 44 creates a user list that indicates a rank based on the degree of similarity between the distribution users specified by the specifying unit 43 and the designated users. Then, the creating unit 44 associates the created user list with the campaign ID of the associated campaign and registers the created user list in the campaign database 33.

The distributing unit 45 distributes an advertisement to the users specified by the specifying unit 43. For example, when the distributing unit 45 accepts an advertisement request from the user U, the distributing unit 45 specifies the user U who is the request source and specifies the user list that includes the specified user U from the campaign database 33. Furthermore, the distributing unit 45 specifies, from among the campaigns associated with the user lists, the campaign of the advertisement that becomes the distribution target, such as the campaign in which the degree of similarity between the attribute information on the user U and the designated attribute is the highest and the campaign in which the rank in the user list is the highest. Furthermore, the distributing unit 45 may also select the campaign of the advertisement that becomes the distribution target by using these pieces of information in an integrated manner. Then, the distributing unit 45 reads, from the advertisement database 32, the content data of the advertisement associated with the selected campaign and distributes the read content data to the user terminal 200 used by the user U.

### 4. Example of the Flow of the Process Performed by the Information Distribution Device

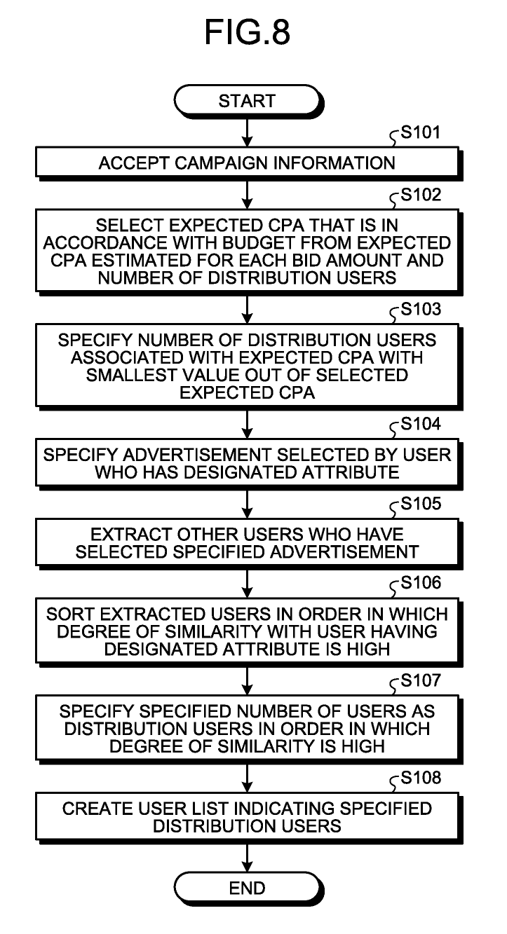

In the following, the flow of the process performed by the information distribution device 10 will be described with reference to FIG. 8. FIG. 8 is a flowchart illustrating an example of the flow of the process performed by the information distribution device according to the embodiment. Furthermore, the information distribution device 10 may perform the process illustrated in FIG. 8 at an arbitrary timing and may also perform the process illustrated in FIG. 8 by dividing the process into arbitrary granularity.

First, when the information distribution device 10 accepts the campaign information from an advertiser (Step S101), the information distribution device 10 selects the expected CPA that is in accordance with the budget from the expected CPA estimated for each bid amount and the number of distribution users (Step S102). Then, the information distribution device 10 specifies the number of distribution users associated with the expected CPA with the smallest value out of the selected expected CPA (Step S103).

Subsequently, the information distribution device 10 specifies the advertisement selected by the designated user who has the attribute matched with the designated attribute (Step S104) and extracts another user who has selected the specified advertisement (Step S105). Then, the information distribution device 10 sorts the extracted users in the order in which the degree of similarity to the user who has the designated attribute is high (Step S106) and specifies the specified number of users as the distribution users in the order in which the degree of similarity is high (Step S107). Then, the information distribution device 10 creates the user list indicating the specified distribution users (Step S108) and ends the process.

### 5. Modification

In the above, an example of the calculation process performed by the information distribution device 10 has been described. However, the embodiment is not limited to this. In the following, a variation in the calculation process performed by the information distribution device 10 will be described.

### 5-1. About the Purpose of the Process

In the example described above, the information distribution device 10 creates a user list of the distribution users who become the distribution destination of an advertisement and distributes the advertisement by using the created user list. However, the embodiment is not limited to this. For example, the information distribution device 10 may also create a user list that is used to distribute arbitrary content, such as images, voices, moving images, electronic books, news feeds, articles of microblogs phone, and may also distribute content based on the created user list.

Furthermore, the information distribution device 10 may also provide the user list to an advertiser when an advertisement or a campaign is registered or may also provide, to an advertiser, the number of distribution users or a bid amount that minimizes the value of the expected CPA. Furthermore, when the information distribution device 10 distributes an advertisement based on the user list, the information distribution device 10 may also select an advertisement in the form of bidding, assuming that a bid for an advertisement has been submitted with a bid amount that minimizes the value of the expected CPA.

### 5-2. Configuration of Device

Furthermore, the information distribution device 10 may also be implemented by the calculation apparatus that executes the calculation process, an expansion device that performs the expanding process, and a distribution device that distributes advertisements in cooperation with each other. Namely, the calculation process and the expanding process may also separately be performed. Furthermore, the information distribution device 10 may also be implemented by a front end server that sends and receives information to and from the user terminal 200 and a back end server that performs various kinds of processes. In this case, the distributing unit 45 illustrated in FIG. 3 is disposed in the front end server, whereas the back end server includes the accepting unit 41, the calculating unit 42, the specifying unit 43, and the creating unit 44. Furthermore, each of the databases 31 to 33 registered in the storage unit 30 may also be held by an external storage server.

### 5-3. Others

Of the processes described in the embodiment, the whole or a part of the processes that are mentioned as being automatically performed can also be manually performed, whereas the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the embodiments described above can be appropriately used in combination as long as the processes do not conflict with each other.

### 5-4. Program

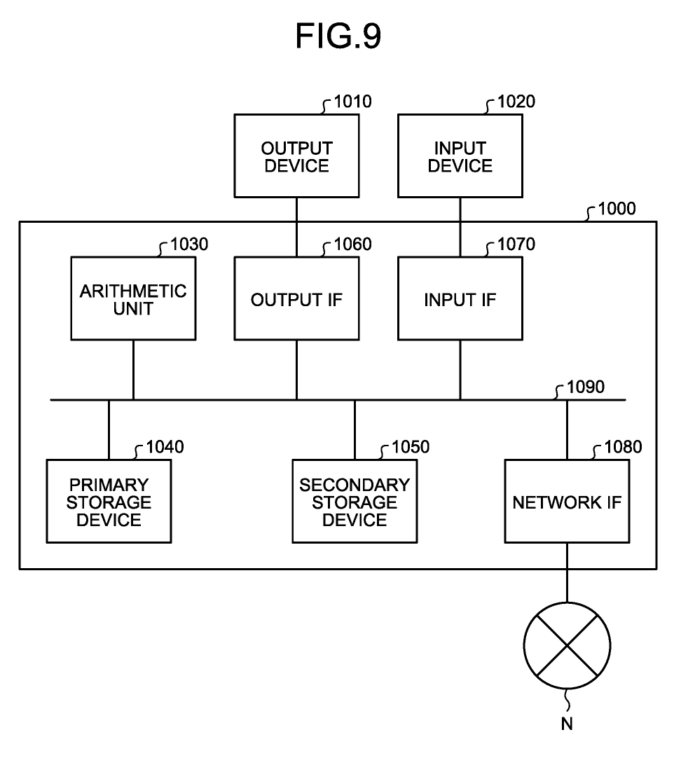

Furthermore, the information distribution device 10 according to the embodiment described above is implemented by a computer 1000 having the configuration illustrated in, for example, FIG. 9. FIG. 9 is a diagram illustrating an example of hardware configuration. The computer 1000 is configured such that the computer 1000 is connected to an output device 1010 and an input device 1020 and includes an arithmetic unit 1030, a primary storage device 1040, a secondary storage device 1050, an output interface (IF) 1060, an input IF 1070, and a network IF 1080 that are connected by a bus 1090.

The arithmetic unit 1030 is operated based on the programs stored in the primary storage device 1040 or the secondary storage device 1050 or based on the programs read from the input device 1020 and performs various kinds of processes. The primary storage device 1040 is a memory device, such as a RAM, that primarily stores therein data that is used by the arithmetic unit 1030 to perform various kinds of arithmetic operations. Furthermore, the secondary storage device 1050 is a storage device in which data that is used by the arithmetic unit 1030 to perform various kinds of arithmetic operations and various kinds of databases are registered and is implemented by a read only memory (ROM), an HDD, a flash memory, and the like.

The output IF 1060 is an interface for sending information that is targeted for an output with respect to the output device 1010, such as a monitor, a printer, or the like, that outputs various kinds of information and is implemented by, for example, the standard connector, such as a universal serial bus (USB), a digital visual interface (DVI), a High Definition Multimedia Interface (registered trademark) (HDMI), or the like. Furthermore, the input IF 1070 is an interface for receiving information from various kinds of the input device 1020, such as a mouse, a keyboard, a scanner, or the like, and is implemented by, for example, an USB, or the like.

Furthermore, the input device 1020 may also be, for example, an optical recording medium, such as a compact disc (CD), a digital versatile disc (DVD), a phase change rewritable disk (PD), or the like; a magneto-optical recording medium, such as a magneto-optical disk (MO), or the like; or a device that reads information from a tape medium, a magnetic recording medium, a semiconductor memory, or the like. Furthermore, the input device 1020 may also be an external storage medium, such as a USB memory, or the like.

The network IF 1080 receives data from another device via the network N and sends the data to the arithmetic unit 1030. Furthermore, the network IF 1080 sends the data created by the arithmetic unit 1030 to the other device via the network N.

The arithmetic unit 1030 controls the output device 1010 and the input device 1020 via the output IF 1060 and the input IF 1070, respectively. For example, the arithmetic unit 1030 loads the program from the input device 1020 or the secondary storage device 1050 into the primary storage device 1040 and executes the loaded program.

For example, if the computer 1000 functions as the information distribution device 10, the arithmetic unit 1030 in the computer 1000 implements the function of the control unit 40 by executing the program loaded in the primary storage device 1040.

### 6. Effects

As described above, the information distribution device 10 accepts, from a set-up person, a budget amount that is a maximum amount of compensation for distribution of information. Then, the information distribution device 10 calculates the number of users who become the distribution destination of the information in accordance with the budget amount. Consequently, because the information distribution device 10 can calculate, for example, the number of users who become the distribution destination of the information and who implements the distribution target that uses up the budget in an appropriate mode, the information distribution device 10 can distribute the information in an appropriate mode in accordance with the budget.

Furthermore, the information distribution device 10 accepts, as the budget amount, the maximum amount of compensation for distribution of the information within a predetermined period of time and calculates, in accordance with the budget amount, the number of users who become the distribution destination of the information within the predetermined period of time. Consequently, the information distribution device 10 can distribute the information in an appropriate mode in accordance with the budget for each period of time even when the budget is set for each predetermined period of time.

Furthermore, the information distribution device 10 specifies, in the order in which the degree of similarity to the designated user is high, the calculated number of users who are similar to a designated user who has an attribute designated by the set-up person. Furthermore, the information distribution device 10 distributes the information to the specified users. Consequently, because the information distribution device 10 can prepare the number of distribution users that is expected to use up the budget in an appropriate manner, the information distribution device 10 can distribute the information in an appropriate mode in accordance with the budget.

Furthermore, the information distribution device 10 specifies, in the order the degree of similarity to the designated user is high, the calculated number of users who have selected an advertisement selected by the designated user. Furthermore, the information distribution device 10 specifies, in the order the degree of similarity to the designated user is high, the calculated number of users who use a similar application used by the designated user. Furthermore, the information distribution device 10 specifies, in the order the degree of similarity to the designated user is high, the calculated number of users who use another application that is similar to the application used by the designated user. Furthermore, the information distribution device 10 specifies, in the order the degree of similarity to the designated user is high, the calculated number of users who have an attribute similar to that held by the designated user. Consequently, the information distribution device 10 can select users who are more similar to the designated user as the number of distribution users that is expected to use up the budget in an appropriate manner.

Furthermore, the information distribution device 10 estimates, for each of the number of users who become the distribution destination of the information, based on the budget amount, an acquisition compensation amount that is a compensation amount needed to acquire users and determines, based on the estimated acquisition compensation amount, the number of users who become the distribution destination of the information. Consequently, because the information distribution device 10 can calculate the number of distribution users that implements an optimum expected compensation amount in accordance with the budget, the information distribution device 10 can distribute the information in an appropriate mode in accordance with the budget.

Furthermore, the information distribution device 10 estimates, for each combination of a distribution compensation amount (i.e., a bid amount) that is a compensation amount of distribution of the information and the number of users who become the distribution destination of the information, the acquisition compensation amount based on the budget amount and determines, based on the estimated acquisition compensation amount, the number of users who become the distribution destination of the information. More specifically, the information distribution device 10 selects a combination of the distribution compensation amount and the number of users who become the distribution destination of the information such that the amount of money expected to be spent within a predetermined period of time is within a predetermined range of the budget amount and estimates, for each selected combination, an acquisition compensation amount. Then, the information distribution device 10 specifies the number of users in a case where an estimated acquisition available amount is the smallest as the number of users who become the distribution destination of the information. Consequently, the information distribution device 10 can calculate the number of distribution users that implements an optimum expected compensation amount in accordance with the budget.

In the above, embodiments of the present invention have been described in detail based on the drawings; however the embodiments are described only by way of an example. In addition to the embodiments described in disclosure of invention, the present invention can be implemented in a mode in which various modifications and changes are made in accordance with the knowledge of those skilled in the art.

Furthermore, the “components (sections, modules, units)” described above can be read as “means”, “circuits”, or the like. For example, the calculating unit can be read as a calculation means or a calculation circuit.

According to an aspect of an embodiment, information can be distributed in a more appropriate mode in accordance with the budget.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A calculation apparatus comprising:
an accepting unit that accepts, from a set-up person, a budget amount that is a maximum amount of compensation for distribution of information; and
a calculating unit that calculates, in accordance with the budget amount, the number of users who become the distribution destination of the information.

2. The calculation apparatus according to claim 1, wherein
the accepting unit accepts, as the budget amount, the maximum amount of compensation for distribution of the information within a predetermined period of time, and
the calculating unit calculates, in accordance with the budget amount, the number of users who become the distribution destination of the information within the predetermined period of time.

3. The calculation apparatus according to claim 1, further comprising a specifying unit that specifies the number of users, who are similar to a designated user who has an attribute designated by the set-up person, that has been calculated by the calculating unit in the order in which the degree of similarity to the designated user is high.

4. The calculation apparatus according to claim 3, further comprising a distributing unit that distributes the information to the users specified by the specifying unit.

5. The calculation apparatus according to claim 3, wherein the specifying unit specifies the number of users, who have selected an advertisement selected by the designated user, that has been calculated by the calculating unit in the order in which the degree of similarity to the designated user is high.

6. The calculation apparatus according to claim 3, wherein the specifying unit specifies the number of users, who use a similar application used by the designated user, that has been calculated by the calculating unit in the order in which the degree of similarity to the designated user is high.

7. The calculation apparatus according to claim 3, wherein the specifying unit specifies the number of users, who use another application similar to the application used by the designated user, that has been calculated by the calculating unit in the order in which the degree of similarity to the designated user is high.

8. The calculation apparatus according to claim 3, wherein the specifying unit specifies the number of users, who have an attribute similar to that held by the designated user, that has been calculated by the calculating unit in the order in which the degree of similarity to the designated user is high.

9. The calculation apparatus according to claim 1, wherein the calculating unit estimates, for each of the number of users who become the distribution destination of the information, based on the budget amount, an acquisition compensation amount that is a compensation amount needed to acquire users and determines, based on the estimated acquisition compensation amount, the number of users who become the distribution destination of the information.

10. The calculation apparatus according to claim 9, wherein the calculating unit estimates, based on the budget amount, for each combination of a distribution compensation amount that is a compensation amount of distribution of the information and the number of users who become the distribution destination of the information, the acquisition compensation amount and determines, based on the estimated acquisition compensation amount, the number of users who become the distribution destination of the information.

11. The calculation apparatus according to claim 10, wherein the calculating unit selects a combination of the distribution compensation amount and the number of users who become the distribution destination of the information such that an amount expected to be spent within a predetermined period of time is within a predetermined range of the budget amount and estimates the acquisition compensation amount for each selected combination of the distribution compensation amount and the number of users who become the distribution destination of the information.

12. The calculation apparatus according to claim 9, wherein the calculating unit specifies the number of users in a case where an estimated acquisition compensation amount is the smallest as the number of users who become the distribution destination of the information.

13. A calculation method performed by a calculation apparatus comprising:
accepting, from a set-up person, a budget amount that is a maximum amount of compensation for distribution of information; and
calculating, in accordance with the budget amount, the number of users who become a distribution destination of the information.

14. A non-transitory computer-readable storage medium having stored therein a calculation program that causes a computer to execute a process comprising:
accepting, from a set-up person, a budget amount that is a maximum amount of compensation for distribution of information; and
calculating, in accordance with the budget amount, the number of users who become a distribution destination of the information.
